(19) United States
(12) Patent Application Publication
(10) Pub. No.: US 2012/0186613 A1
(43) Pub. Date: Jul. 26, 2012

(54) Drive Chain

(75) Inventors: Michael Siegmund, Harrislee (DE); Helmut Browatzki, Esgrus (DE)

(73) Assignee: KRONES AG, Neutraubling (DE)

(21) Appl. No.: 13/357,665

(22) Filed: Jan. 25, 2012

(30) Foreign Application Priority Data
Jan. 26, 2011 (DE) 102011003198.7

(51) Int. Cl. B08B 9/42; F16G 13/02; B08B 9/46; B65G 17/38

(52) U.S. Cl. 134/56 R; 198/851; 134/71

(57) ABSTRACT

A drive chain for a container cleaning machine having a plurality of chain links connected to one another by means of bolts and strung together in an articulated manner as well as having idler rollers supported on the bolt in a manner, that allows rotation. The idler rollers of the drive chain are arranged outside the chain links that are connected to one another and secured to the bolt by a holding device in such a way that the individual idler rollers can be exchanged independently of one another.

### CROSS-REFERENCE TO RELATED APPLICATION

The present application claims the benefit of priority of German Application No. 102011003198.7, filed Jan. 26, 2011. The entire text of the priority application is incorporated herein by reference in its entirety.

### FIELD OF THE DISCLOSURE

The disclosure relates to a drive chain for a container cleaning machine as well as to a container cleaning machine.

A container cleaning machine of this description that is executed with a chain transport system is known, for example, from DE 10 2009 006492 A1. This comprises a plurality of treatment zones, whereby the containers that are to be treated are moved through these treatment zones with the help of the transport system. The transport system thereby comprises a drive chain that consists of a plurality of chain links connected to one another by means of bolts and strung together in an articulated manner. Idler rollers that are supported on the bolts in a rotatable manner are arranged between the chain links, whereby these idler rollers represent the bearing element of the drive chain. The drive chain is subject to a high level of wear during operation, especially in the area of the idler rollers. Chemical action due to the use of immersion, softening or alkaline baths, wear and tear due to the continuously high mechanical load, and also thermal influences in the various treatment zones necessitate maintenance of the chain or inspection of the condition at periodic intervals, which is associated with a large assembly effort and consequently also with high costs.

### SUMMARY OF THE DISCLOSURE

The basis of the disclosure is therefore formed by proposing a drive chain for a container cleaning machine that can be used as long as possible with the least possible maintenance effort.

In the case of the drive chain according to the disclosure, the idler rollers are arranged outside the chain links that are connected to one another instead of between the chain links. The idler rollers are thereby secured on a bolt by a holding device. The holding device is thereby executed in such a way that it secures the idler roller to prevent it from breaking out laterally on the one hand and, on the other hand, it allows the simple exchange of individual idler rollers independently of other idler rollers or operational elements of the drive chain. For this purpose, the holding device can be, for example, an element with or a constituent of a screwed, plug-in, latching or snap-on connection for securing the idler roller. By means of this design change to the chain configuration, the simple liberation and exchange of individual idler rollers is made possible, whereby the remaining components of the drive chain can be kept in such a state that they are ready for use and whereby a significant extension of the lifespan of the entire drive chain is achieved.

This drive chain is used for transporting receptacles through the treatment zones in a container cleaning machine according to the disclosure. Openings are thereby provided on the housing surrounding the container cleaning machine, whereby the idler rollers can be inspected and replaced through these openings.

The holding device for securing the idler roller on the bolt can preferably be executed as a splint, spring cotter, clamping ring, set collar or retaining ring. In this way, the holding device can be detached from the bolt and the idler roller secured therewith can be removed and exchanged from the drive chain, without it being necessary to detach or even exchange further components of the drive chain. After the exchange of the worn-out idler roller, the holding device can be attached again or brought into a position that is suitable for securing the idler roller.

The idler rollers preferably are made of a combination of different materials, e.g., steel or plastics such as POM, PA, PEEK, for reducing the moved mass, the costs and the maintenance associated therewith, as well as for improving the durability. The idler rollers can furthermore be formed as smooth running rollers with, for example, a needle bearing, for reducing the friction coefficient.

In a preferred embodiment, the idler rollers additionally have a wearing surface that is preferably applied to the running surface of the roller. If the wearing surface is formed in such a way that it can be visually distinguished from the idler roller material lying underneath it, the wear and tear on the idler roller can in this way be inspected and ascertained in a simple manner, for example, by means of a visual inspection.

In the container cleaning machine according to the disclosure, the drive chain is used for transporting the containers provided for cleaning. The drive chain is thereby preferably connected to a carrier that is suitable for receiving the receptacles that are to be cleaned. In addition, it is also possible that the drive chain has common components with the carrier itself.

The container cleaning machine according to the disclosure preferably has a surrounding housing that has at least one opening through which access to the drive chain running in the housing interior, particularly to its idler rollers, is made possible. The opening is thereby arranged in such a way that the inspection of the idler rollers or their wearing surface is made possible on the one hand, and, on the other hand, direct access to the inspected idler rollers is made possible if it has been determined that there is a need for an exchange. If this access is formed, for example, as a hatch with an inspection window, the idler rollers can also be inspected without interrupting the cleaning operation of the container cleaning machine.

### BRIEF DESCRIPTION OF THE DRAWINGS

Further advantages and embodiments result from the attached drawings. Shown therein are:

FIG. 1 shows a schematic top view on to a drive chain according to the disclosure;

FIG. 2 shows a schematic side view of an idler roller;

FIGS. 3a and 3b show a possible method for determining the wear and tear on an idler roller;

FIG. 4 shows a schematic cross-sectional view of a container cleaning machine according to the disclosure.

### DETAILED DESCRIPTION OF THE PREFERRED EMBODIMENT

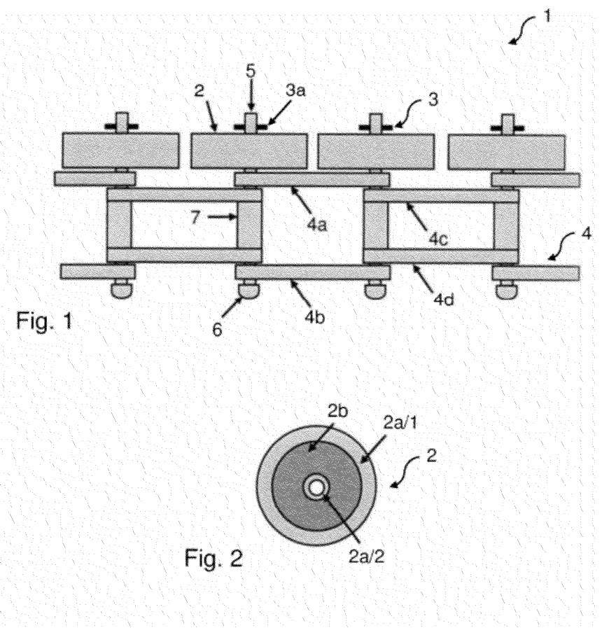

FIG. 1 shows a drive chain 1 according to the disclosure. This drive chain 1 comprises a plurality of chain links 4 that are connected to one another by means of a bolt 5 and that are strung together in an articulated manner. A sleeve 7 can be provided between the inner chain links 4c, 4d as a spacer through which the bolt 5 extends. The inner chain links 4c, 4d and the outer chain links 4a, 4b together enclose the inner area of the chain. The bolt 5 thereby juts into the outer area of the chain with both ends. An end piece 6 that is usually permanently connected to the bolt is provided on the one end of the pin-shaped bolt 5 for securing the chain connection. An idler roller 2 that is supported in the outer area is supported in a rotatable manner on the bolt 5 on the other side of the bolt. A detachable holding element 3 secures the idler roller 2 from breaking out in the axial direction.

The drive chain 1 shown here uses a splint 3a as the holding element 3. During the assembly, the splint 3a is inserted in a bore hole (not shown) provided for this purpose, at a right angle to the longitudinal axis of the bolt and it secures the idler roller from breaking out laterally. In addition, the holding element can also be executed as a spring cotter, clamping ring, set collar or retaining ring.

If the wear and tear on a single idler roller 2 is too great and makes an exchange necessary, the associated splint 3a is removed. This allows the idler roller to be axially drawn off of the bolt and replaced with a new idler roller. The splint is subsequently mounted again, whereby the exchange of the idler roller is complete. In this way, all idler rollers 2 can be replaced independently of the other components of the drive chain 1.

FIG. 2 shows an embodiment of the idler roller 2 of the drive chain 1 according to the disclosure as shown in FIG. 1. The idler roller 2 is preferably executed as a smooth running roller and has on its running surface a wearing surface 2a/1 or, in the area of the support for the bolt 5 a wearing surface 2a/2 that differs visually from the remaining material of the idler roller 2b. The state of the wear on the idler roller can hereby be examined by a simple visual inspection of the wearing surface 2a/1 or 2a/2. In addition, the state of the wear on the idler rollers can also be determined with the help of a sensor unit.

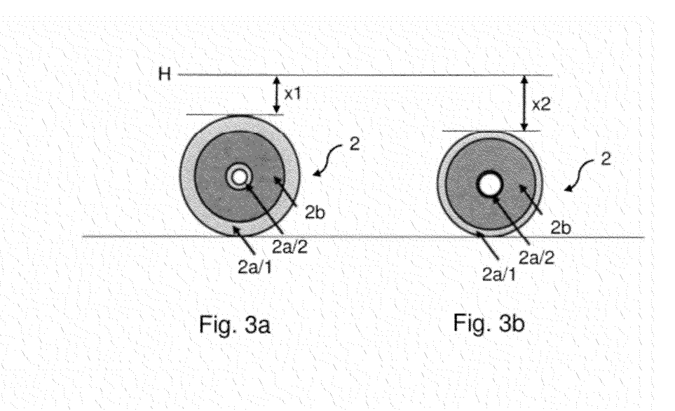

As shown in FIGS. 3a and 3b, the state or the wear and tear on the wearing surface 2a/1 can preferably be inspected by measuring a distance with respect to a defined measurement point. An idler roller 2 with bolt 5 which shows no wear and tear has, for example, a distance xl between the upper edge of the idler roller 2 and a defined height line H. If the idler roller shows wear in the area of the wearing surface 2a/1, this distance increases to a value x2, as shown in FIG. 3b. If the distance exceeds a critical value, the wear on this idler roller is too great and the idler roller 2 must be exchanged. The wear and tear on the wearing surface 2a/2 and the wear on the bolt 5 could just as well be inspected in an analogous measurement method.

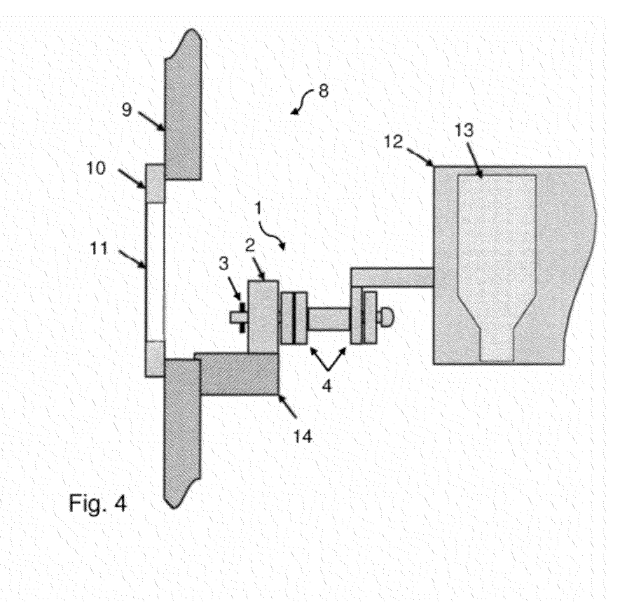

FIG. 4 shows a detail of the container cleaning machine 8 according to the disclosure. The depiction shows a view looking in the direction of travel of the drive chain 1 as described in FIG. 1, which extends within the container cleaning machine 8. Individual chain links 4 of the drive chain are connected to a carrier 12 that is suitable for receiving the receptacles 13 that are to be cleaned. The idler roller 2 of the drive chain lies on a guide rail 14 that gives the direction of travel of the drive chain. The drive chain 1 is thereby essentially oriented in such a way that the idler roller 2 and the splint 3a point away from the carrier 12 in the direction of the housing 9. The guide rail 14 is thereby preferably connected to the surrounding housing 9 of the container treating machine 8.

In this embodiment of the container cleaning machine 8, two transport chains 1 running in parallel are used that are connected to the carrier on opposite sides of the same. For the sake of simplicity, only a portion of the transport system is shown here.

At least one opening is additionally provided in the housing 9, whereby this opening can be closed by a hatch 10. An inspection window 11 is preferably arranged on the hatch 10 or on the housing 9. The hatch 10 is thereby designed in such a way that when necessary, it can be opened, the idler roller replacement can be executed through it, and then it can be closed again. The inspection window 11 is thereby arranged in such a way that the wear and tear on the idler roller 2 can be inspected in front of the opening through the closed hatch.

The inspection of the state of the idler roller 2 or of the wearing surface 2a/1 or 2a/2 can thereby also take place through the inspection window 11 during the operation of the container cleaning machine 8. In addition, the state of the wear on the idler rollers or the bolts can also be determined with the help of an optical or mechanical sensor unit. The worn idler roller or the bolt can then selectively be transported to a hatch 10 with the help of a corresponding program.

In the embodiments shown here, the drive chain 1 always consists of two rows of chain links 4a, 4c and 4b, 4d that run in parallel and that are spatially separated from each other by a sleeve 7. The drive chain 1 could also just as well be executed in a variant without a sleeve 7 and/or a second chain link row 4b, 4d.

1. A drive chain for a container cleaning machine, comprising a plurality of chain links connected to one another by means of bolts and strung together in an articulated manner, idler rollers supported on each bolt in a manner that allows rotation, the idler rollers being arranged outside of the chain links that are connected to one another and being secured to the bolt by a holding device in such a way that the individual idler rollers can be exchanged independently of one another.

2. The drive chain according to claim 1, wherein the holding device is executed as one of a splint, a spring cotter, a clamping ring, a set collar, and a retaining ring.

3. The drive chain according to claim 1, wherein the holding device is connected to the bolt by means of a screwed connection.

4. The drive chain according to claim 1, wherein the holding device is connected to the bolt by means of a plug-in connection.

5. The drive chain according to claim 1, wherein the holding device is connected to the bolt by means of a latching connection.

6. The drive chain according to claim 1, wherein the holding device is connected to the bolt by means of a snap-on connection.

7. The drive chain according to claim 1, wherein the idler roller comprises plurality of materials.

8. The drive chain according to claim 1, wherein the idler rollers are formed as smooth running rollers.

9. The drive chain according to claim 1, wherein the idler rollers have one of a wearing surface on a running surface thereof, or a wearing surface in the area of the support for the bolt, and a combination thereof.

10. A container cleaning machine comprising one or more drive chains formed according to claim 1.

11. The container cleaning machine according to claim 10, wherein one of the drive chain is connected to a carrier and has parts in common with the carrier, which is suitable for receiving the receptacles that are to be cleaned.

12. The container cleaning machine according to claim 10, wherein at least one closable opening that can also comprise an inspection window, is provided on a housing of the container cleaning machine, wherein the idler rollers of the drive chain can be inspected and exchanged through the closable opening.

13. The container cleaning machine according to claim 12, and a programmed sensor unit arranged on the container cleaning machine, wherein the sensor unit determines the wear on the idler roller and wherein the wear-determined idler roller can then be selectively moved to the at least one closable opening.

14. The drive chain according to claim 1, wherein the holding device is a constituent of a screwed connection for securing the idler roller.

15. The drive chain according to claim 1, wherein the holding device is a constituent of a plug-in connection for securing the idler roller.

16. The drive chain according to claim 1, wherein the holding device is a constituent of a latching connection for securing the idler roller.

17. The drive chain according to claim 1, wherein the holding device is a constituent of a snap-on connection for securing the idler roller.

18. The drive chain according to claim 9, wherein the wearing surface of the idler rollers can be detected visually.

19. The container cleaning machine according to claim 12, wherein the at least one closable opening comprises a hatch.
